(19) United States
(12) Patent Application Publication
(10) Pub. No.: US 2002/0176070 A1
(43) Pub. Date: Nov. 28, 2002

(54) Method and apparatus for measuring chromatic dispersion in optical fibers

(75) Inventors: Martin Achtenhagen, Bradley Beach, NJ (US); Idan Mandelbaum, Piscataway, NJ (US)

Correspondence Address: Hall, Priddy, Myers & Vande Sande, Suite 200, 10220 River Road, Potomac, MD, 20854, US

(73) Assignee: JDS Uniphase Corporation

(21) Appl. No.: 09/909,793

(22) Filed: Jul. 23, 2001

Related U.S. Application Data
(60) Provisional application No. 60/291,985, filed on May 21, 2001.

(51) Int. Cl. G01N 21/00

(52) U.S. Cl. 356/73.1

(57) ABSTRACT

An apparatus for measuring chromatic dispersion in a waveguide uses a CW laser probe signal and a modulated pump signal which are coupled together into a waveguide. The modulated pump signal causes spatial and temporal Raman gain modulation of the probe signal. The amplitude of the pump signal is modulated and the frequency response of the probe signal at the output end of the waveguide is measured. The chromatic dispersion of the waveguide at a given wavelength is determined from the measurements.

### CROSS-REFERENCE TO RELATED APPLICATIONS

This application claims priority of U.S. Provisional Application No. 60/291,985 filed May 21, 2001.

### TECHNICAL FIELD

The present application relates to a method and apparatus for measuring chromatic dispersion in optical waveguides for optical communication, and more specifically to such method and apparatus using Raman effect.

### BACKGROUND OF THE INVENTION

Chromatic dispersion occurs in optical waveguides due to differences of propagation speeds at various wavelengths. Therefore, the optical pulse signal expands as it travels along the waveguide, deforming the waveform and causing crosstalk between adjacent channels.

It is desirable to measure the chromatic dispersion in optical waveguides in order to provide proper dispersion compensation. Presently known methods of measuring dispersion rely on measuring the phase shift of a modulated signal along the fiber (waveguide). The dispersion can be derived from the phase shift.

In U.S. Pat. No. 5,189,483, Inagaki describes a method based on transmitting a laser pulse generated by Raman oscillation through a sample fiber. At the output end of the fiber, a reference wavelength light and an object wavelength light are received and a delay time of the object wavelength light relative to the reference wavelength light is measured as a factor of a chromatic dispersion of the sample fiber.

In the Inagaki system, the Raman gain takes place in the measuring instrument, and not in the waveguide under test.

It is desirable to measure chromatic dispersion without requiring phase information i.e. without extracting phase properties of the signal at both ends of the waveguide which requires complex electronics.

### SUMMARY OF THE INVENTION

According to the invention, a modulated pump signal and a probe signal are propagated through a waveguide medium and the ratio of the modulation power of the pump signal to the modulation power of the output signal is measured and related to the chromatic dispersion.

The Raman gain varies along the fiber spatially and temporally due to the modulated pump signal. These variations get transferred to the probe signal. The efficiency of the transfer between the pump modulation and the probe modulation at the output of the waveguide depends on the difference in group velocity of the signals, which relates to the chromatic dispersion between the two wavelengths. The amplitude of both signal modulations are measured and related to the dispersion.

According to the present invention, there is provided a method for an efficient determination of chromatic dispersion in an optical waveguide, the method comprising:

a) inputting a modulated narrowband pump signal into the input end of the waveguide to generate Raman gain in the waveguide,

b) inputting a narrowband probe signal into the input end of the waveguide, the probe signal having a wavelength that is within Raman gain band characteristic of the waveguide,

c) combining the pump signal and the probe signal at the input end of the waveguide,

d) impressing the modulation of the pump signal on the probe signal through temporal and spatial Raman gain modulation in the waveguide,

e) varying the modulation frequency of the pump signal,

f) measuring frequency response of the probe signal at the output end of the waveguide while the modulation frequency of the pump signal is varied, and

g) determining the group delay from the frequency response of the probe signal.

The probe signal is separated from the pump signal at the output end of the waveguide.

In another aspect of the invention, there is provided a method for measuring chromatic dispersion of an optical waveguide having an input end and an output end, the method comprising:

a) inputting a modulated narrowband pump signal into the input end of the waveguide to generate Raman gain in the waveguide,

b) inputting a narrowband probe signal into the input end of the waveguide, the probe signal having a wavelength that is within Raman gain band characteristic of the waveguide,

c) combining the pump signal and the probe signal at the input end of the waveguide,

d) impressing the modulation of the pump signal on the probe signal through temporal and spatial Raman gain modulation in the waveguide,

e) varying the modulation frequency of the pump signal,

f) measuring frequency response of the probe signal at the output end of the waveguide while the modulation frequency of the pump signal is varied,

g) determining the group delay from the frequency response of the probe signal,

h) varying the wavelength of the probe signal,

i) repeating steps a) to g) for different probe wavelengths to determine a relationship of group delay and wavelength, and

j) determining the chromatic dispersion of the waveguide from said relationship.

In still another aspect of the invention, there is provided an apparatus for measuring chromatic dispersion in an optical waveguide, the apparatus comprising An apparatus for measuring chromatic dispersion of a waveguide having an input end and an output end, the apparatus comprising

a source of a probe signal operatively coupled to the input end of the waveguide,

a source of a Raman wavelength pump signal operatively coupled to the input end of the waveguide,

a modulator means coupled to the source of a pump signal to modulate the pump signal to be input into the waveguide,

means for separating the probe signal from the pump signal at the output end of the waveguide, and

detector means for detecting and measuring, at the output end of the waveguide, frequency response of the probe signal to the frequency modulation.

The apparatus may further comprise combining means for combining the pump signal and the probe signal at the input end of the waveguide, and means for separating the pump signal and the probe signal at the output end of the waveguide.

The modulator means may be an external intensity modulator operatively connected to the pump signal source. It may be embodied by an electrical modulator or by an optical modulator.

### BRIEF DESCRIPTION OF THE DRAWINGS

Further features and advantages of the present invention will become apparent from the following detailed description, taken in conjunction with the appended drawings, in which:

FIG. 1 represents a block diagram of an apparatus for measuring chromatic dispersion, according to the invention

FIG. 2 is a graph illustrating relationship between experimental values and the theoretical values of chromatic dispersion; and

FIG. 3 is a graph of experimental group delay vs. wavelength based on Sellmeier's equation.

It will be noted that throughout the appended drawings, like features are identified by like reference numerals.

### DETAILED DESCRIPTION OF THE PREFERRED EMBODIMENT

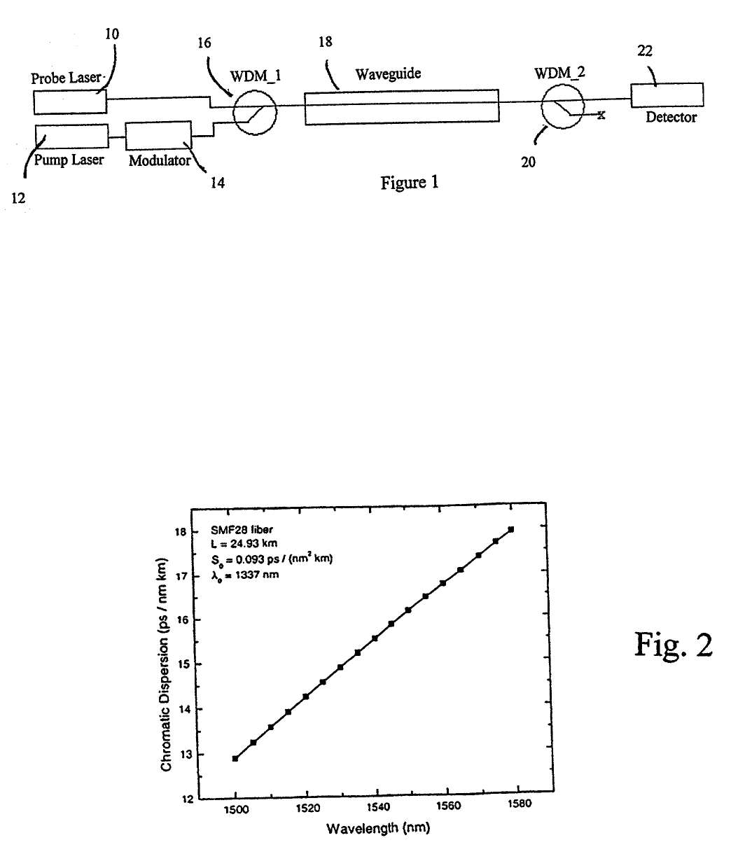

In a preferred embodiment of the apparatus of the invention, illustrated in FIG. 1, a probe laser 10 is selected to provide a continuous signal at the desired wavelength at which chromatic dispersion is to be measured. A pump laser 12 provides a continuous signal at the desired Raman pumping wavelength. Since the apparatus (and the method) operate in the Stokes regime (in which pumping energy is passed to the probe signal), the pumping wavelength must preferably be of higher energy and therefore of shorter wavelength than the probe laser wavelength. The pump wavelength used is determined by the media under test. Usually, for silica glass, it is desired to have the central wavelength of the probe band to be about 13.2 THz lower than the pump wavelength. In the actual experiments, a pump wavelength of 1447 nm was used, but since relatively little gain is needed in the measurement of chromatic dispersion and the Raman gain curve spans a relatively wide wavelength range, a single pump laser should be sufficient for each communication band (L, C, S, corresponding to 1565-1620 nm, 1525-1565 nm and 1450 nm to 1520 nm etc).

A modulator 14 is coupled to the pump laser 12 and to a multiplexer 16 to modulate the pump signal which is then combined with the probe laser signal. The combined signal is input to a waveguide 18. The waveguide may be a single-mode optical fiber and its length should be at least about one kilometer in order to have sufficient dispersion to give a measurable effect. Due to the inherent nonlinear properties of the waveguide, some coupling takes place between the pump signal and the probe signal in the waveguide. The combined signal is separated in a demultiplexer 20 back into the pump signal and the probe signal. The latter is presented to a detector 22 which in the specific embodiment has a photodiode, a transimpedance amplifier and a pass-band filter at the frequency of modulation, followed by an amplitude detector to detect the signal power at the modulation frequency. Using known parameters of the fiber and modulation strength, the dispersion can then be calculated using the power detected at the given modulation frequency.

The normalized frequency response H(ω), obtained from scanning the modulation frequency of the pump and detecting the modulation transfer to the signal, resembles the response of a low-pass filter and can be characterized by the following equation:

$$H ( ω ) = \frac{1}{1 + {( \frac{ωτ}{{α}_{p} L} )}^{2}} \frac{( 1 - 2 {e}^{- {α}_{p} L} cos ( ω τ ) + {e}^{- 2 {α}_{p} L} )}{{( 1 - {e}^{- {α}_{p} L} )}^{2}} \qquad ( 1 )$$

where τ is the relative group delay, αₚ is the fiber loss per unit length at the pump wavelength, ω equals 2πf where f is modulation frequency of a pump, and L is the length of the fiber.

Fitting the frequency response obtained experimentally to equation (1) results in the determination of parameter τ for a particular probe wavelength. The measurement of chromatic dispersion requires the determination of τ(λ) for a sequence of wavelengths.

The dispersion D (λₛ) can then be determined by using the following equation

$$D ( {λ}_{s} ) = \frac{1}{L} \cdot \frac{ⅆ τ ( λ )}{ⅆ λ} {\vert}_{λ = {λ}_{s}} \qquad ( 2 )$$

where λₛ is the wavelength of the probe being used.

FIG. 2 represents a relationship between experimental data of chromatic dispersion (squares) and the theoretical values (line). It can be seen that the relationship (fit) is very good.

Better results are achieved if τ, the experimental group delay, is made to fit the Sellmeier's equation (3) before using equation (2) which smoothes the data before the derivative thus reducing the noise.

τ=aλ²+b+cλ⁻² (3)

where a, b and c are parameters determined by fitting experimental data to Sellmeier's equation.

The chromatic dispersion can be derived from Eq. (3) by using equation (2).

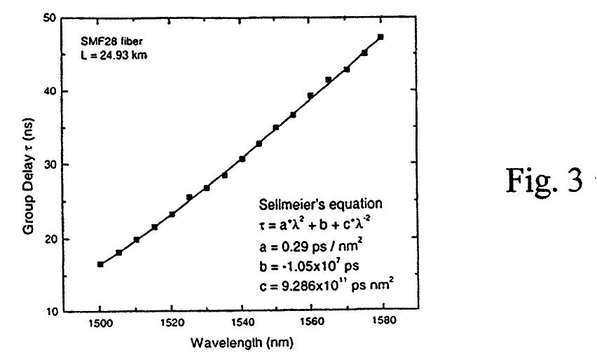

The results obtained using the iterative approach with the combination of Sellmeier's equation are presented in FIG. 3.

It can be seen in FIG. 3 that the relationship between the group delay and the wavelength corresponds well to the Sellmeier's equation with parameters a, b and c as shown in the FIG. 3.

In summary, the method and apparatus described above enable the determination of chromatic dispersion in a waveguide by using spatial and temporal Raman gain modulation. The Raman effect gives rise to a transfer of modulation from the pump signal to the probe signal. The efficiency of the transfer is controlled by the dispersion. Dispersion can thus be determined from this relationship.

The embodiment of the invention described above is intended to be exemplary only. The scope of the invention is therefore intended to be limited solely by the scope of the appended claims.

We claim:

1. A method for measuring group delay of an optical waveguide having an input end and an output end, the method comprising:
a) inputting a modulated narrowband pump signal into the input end of the waveguide to generate Raman gain in the waveguide,
b) inputting a narrowband probe signal into the input end of the waveguide, the probe signal having a wavelength that is within Raman gain band characteristic of the waveguide,
c) combining the pump signal and the probe signal at the input end of the waveguide,
d) impressing the modulation of the pump signal on the probe signal through temporal and spatial Raman gain modulation in the waveguide,
e) varying the modulation frequency of the pump signal,
f) measuring frequency response of the probe signal at the output end of the waveguide while the modulation frequency of the pump signal is varied, and
g) determining the group delay from the frequency response of the probe signal.

2. The method of claim 1 further comprising the step of separating the probe signal from the pump signal at the output end of the waveguide.

3. The method of claim 1 wherein the step of determining the group delay is based on the equation
$$H ( ω ) = \frac{1}{1 + {( \frac{ωτ}{{α}_{p} L} )}^{2}} \frac{( 1 - 2 {e}^{- {α}_{p} L} cos ( ωτ ) + {e}^{- 2 {α}_{p} L} )}{{( 1 - {e}^{- {α}_{p} L} )}^{2}}$$
where τ is the relative group delay (between the pump and the probe), αₚ is the fiber loss per unit length at the pump wavelength, ω equals 2πf where f is modulation frequency of a pump, and L is the length of the fiber.

4. A method for measuring chromatic dispersion of an optical waveguide having an input end and an output end, the method comprising:
a) inputting a modulated narrowband pump signal into the input end of the waveguide to generate Raman gain in the waveguide,
b) inputting a narrowband probe signal into the input end of the waveguide, the probe signal having a wavelength that is within Raman gain band characteristic of the waveguide,
c) combining the pump signal and the probe signal at the input end of the waveguide,
d) impressing the modulation of the pump signal on the probe signal through temporal and spatial Raman gain modulation in the waveguide,
e) varying the modulation frequency of the pump signal,
f) measuring frequency response of the probe signal at the output end of the waveguide while the modulation frequency of the pump signal is varied,
g) determining the group delay from the frequency response of the probe signal,
h) varying the wavelength of the probe signal,
i) repeating steps a) to g) for different probe wavelengths to determine a relationship of group delay and wavelength, and
j) determining the chromatic dispersion of the waveguide from said relationship.

5. The method of claim 4 further comprising the step of separating the probe signal from the pump signal at the output end of the waveguide.

6. The method of claim 4 wherein the relationship is fit to Sellmeier's equation
τ=aλ²+b+cλ⁻²
where a, b and c are parameters determined by fitting experimental data to the equation,
to determine the chromatic dispersion.

7. An apparatus for measuring chromatic dispersion of a waveguide having an input end and an output end, the apparatus comprising
a source of a probe signal operatively coupled to the input end of the waveguide,
a source of a Raman wavelength pump signal operatively coupled to the input end of the waveguide,
a modulator means coupled to the source of a pump signal to modulate the pump signal to be input into the waveguide,
means for separating the probe signal from the pump signal at the output end of the waveguide, and
detector means for detecting and measuring, at the output end of the waveguide, frequency response of the probe signal to the frequency modulation.

8. The apparatus of claim 7 further comprising combining means for combining the pump signal and the probe signal at the input end of the waveguide.

9. The apparatus of claim 7 further comprising means for separating the pump signal and the probe signal at the output end of the waveguide.

10. The apparatus of claim 7 wherein the modulator means is an external intensity modulator operatively connected to the pump signal source.

11. The apparatus of claim 7 wherein the modulator means is an electrical modulator.

12. The apparatus of claim 7 wherein the modulator means is an optical modulator.
